(19) United States
(12) Patent Application Publication
(10) Pub. No.: US 2026/0088451 A1
(43) Pub. Date: Mar. 26, 2026

(54) BATTERY CELLS WITH SEPARATORS INCLUDING JOINED ENDS

(71) Applicant: GM GLOBAL TECHNOLOGY OPERATIONS LLC, Detroit, MI (US)

(72) Inventors: Young Nam KIM, Troy, MI (US); Reza Kavian, Sterling Heights, MI (US); Matthew Arthur Celentano, Berkley, MI (US)

(21) Appl. No.: 18/897,937

(22) Filed: Sep. 26, 2024

(51) Int. Cl. H01M 50/463; H01M 10/0525; H01M 10/0585; H01M 50/403

(52) U.S. Cl. CPC H01M 50/463; H01M 10/0525; H01M 10/0585; H01M 50/403; H01M 2220/20

(57) ABSTRACT

A battery cell includes C cathode electrodes each including a cathode active material arranged on a cathode current collector, A anode electrodes each including an anode active material arranged on an anode current collector, and S separators. C, A, and S are integers greater than one. The S separators include first ends and second ends. The first ends and the second ends of the S separators extend from opposite sides of the C cathode electrodes and the A anode electrodes. The first ends and the second ends of the S separators are connected together using hot pressing, a hot knife, a polymer bath, or ultrasonic welding.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including separators with joined ends.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes each including a cathode active material arranged on a cathode current collector, A anode electrodes each including an anode active material arranged on an anode current collector, and S separators. C, A, and S are integers greater than one. The S separators include first ends and second ends. The first ends and the second ends of the S separators extend from opposite sides of the C cathode electrodes and the A anode electrodes. The first ends of the S separators are connected together.

In other features, the second ends of the S separators are connected together. The first ends and the second ends of the S separators are connected together using a hot press. The first ends and the second ends of the S separators are connected together using a hot knife.

In other features, the first ends and the second ends of the S separators are connected together using a polymer connector. The polymer connector is formed by dipping the first ends and the second ends of the S separators in a polymer bath.

In other features, the first ends and the second ends of the S separators are connected together using ultrasonic welding.

In other features, tape extends over at least a portion of the first ends and the second ends of the S separators. The tape is located at discrete locations that are spaced in a longitudinal direction.

A vehicle includes a battery module including a plurality of the battery cell.

A method for manufacturing a battery cell includes arranging C cathode electrodes each including a cathode active material arranged on a cathode current collector, A anode electrodes each including an anode active material arranged on an anode current collector, and S separators in a battery cell stack. C, A, and S are integers greater than one.

The S separators include first ends and second ends. The first ends and the second ends of the S separators extend from opposite sides of the C cathode electrodes and the A anode electrodes. The method includes connecting the first ends of the S separators together.

In other features, the method includes connecting the second ends of the S separators together. The first ends and the second ends of the S separators are connected together using a hot press. The first ends and the second ends of the S separators are connected together using a hot knife.

In other features, the first ends and the second ends of the S separators are connected together using a polymer connector. The method includes dipping the first ends and the second ends of the S separators in a polymer bath to form a first polymer connector connecting the first ends and a second polymer connector connecting the second ends.

In other features, the first ends and the second ends of the S separators are connected together using ultrasonic welding.

In other features, the method includes wrapping at least a portion of the first ends and the second ends of the S separators using tape. The tape is located at discrete locations that are spaced along the battery cell in a longitudinal direction.

In other features, the method includes arranging a plurality of the battery cell in a battery module, and arranging the battery module in a vehicle.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including C cathode electrodes, A anode electrodes, and S separators arranged in a battery cell stack according to the present disclosure;

FIG. 2A is a side cross section of an example of a battery cell including S separators extending from sides thereof and tape wrapped around the battery cell;

FIGS. 2B and 2C are perspective views of an example of battery cells including tape wrapped around the battery cell;

FIG. 3A is a side cross section of an example of a battery cell including S separators extending from sides thereof and connected by dipping ends of the S separators in a polymer bath according to the present disclosure;

FIG. 3B is a side cross section of an example of the battery cell of FIG. 3A after connection using a polymer adhesive according to the present disclosure;

FIG. 4A is a side cross section of an example of a battery cell including S separators extending from sides thereof during connection using a hot press according to the present disclosure;

FIG. 4B is a side cross section of an example of the battery cell of FIG. 4A after connection using the hot press according to the present disclosure;

FIG. 5A is a side cross section of an example of a battery cell including S separators extending from sides thereof during connection using a hot knife according to the present disclosure;

FIG. 5B is a side cross section of an example of the battery cell of FIG. 5A after being connected using the hot knife according to the present disclosure;

FIG. 6A is a side cross section of an example of a battery cell including S separators extending from sides during connection using an ultrasonic welder according to the present disclosure; and

FIG. 6B is a side cross section of an example of the battery cell of FIG. 6A after being connected using the ultrasonic welder according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Battery cells include anode electrodes, cathode electrodes, and separators arranged between the anode electrodes and cathode electrodes. Pull back or folding of the separators may cause soft short circuits after manufacture. The present disclosure relates to joining the ends of the separators after lamination and stacking to prevent separator delamination after manufacturing. By joining ends of all of the separators together on each side, there is a lower risk for one or more separators to pull back or fold and the likelihood of soft short circuits is reduced.

The edges of the separators are joined according to the present disclosure using various methods such as a polymer adhesive, hot pressing, hot knife/melting, and/or ultrasonic welding. In some examples, the joining brings all of the separators on each side together toward a center of the battery cell making the separators near the stack edge less prone to pull back or fold. In some examples, tape is not used, which reduces cost. In other examples, tape is optionally applied after joining to provide additional support.

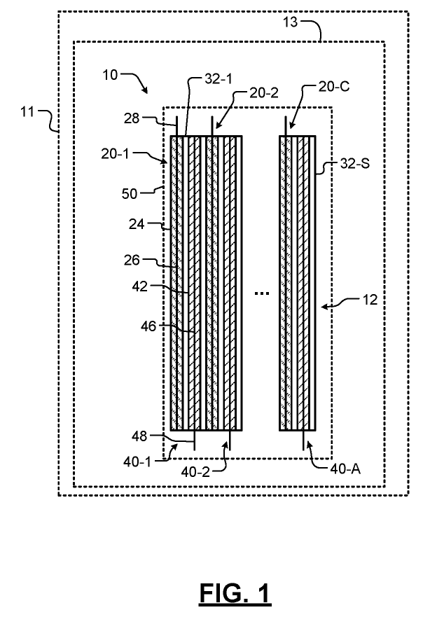

Referring now to FIG. 1, an example of a battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module (or battery pack 13) including the battery cell 10.

The battery cell stack 12 is arranged in an enclosure 50. Additional battery cells 10 may be combined into battery modules and/or battery stacks. The C cathode electrodes 20-1, 20-2, ..., and 20-C include a cathode active material layer 24 on one or both sides of a cathode current collector 26. The A anode electrodes 40-1, 40-2, ..., and 40-A include an anode active material layer 42 arranged on an anode current collector 46.

In some examples, the A anode electrodes 40 and the C cathode electrodes 20 exchange lithium ions during charging and discharging. In some examples, the cathode active material layers 24 and/or anode active material layers 42 comprise coatings including one or more active materials, solid electrolyte (for solid and semi-solid battery cells), one or more conductive additives or fillers, and/or one or more binder materials that are applied to the current collectors.

In some examples, the cathode current collector 26 comprises metal foil, metal mesh, perforated metal, 3 dimensional (3D) metal foam, and/or expanded metal. In some examples, the current collectors are made of one or more foil materials selected from a group consisting of copper, stainless steel, aluminum, alloys thereof, or other suitable materials. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

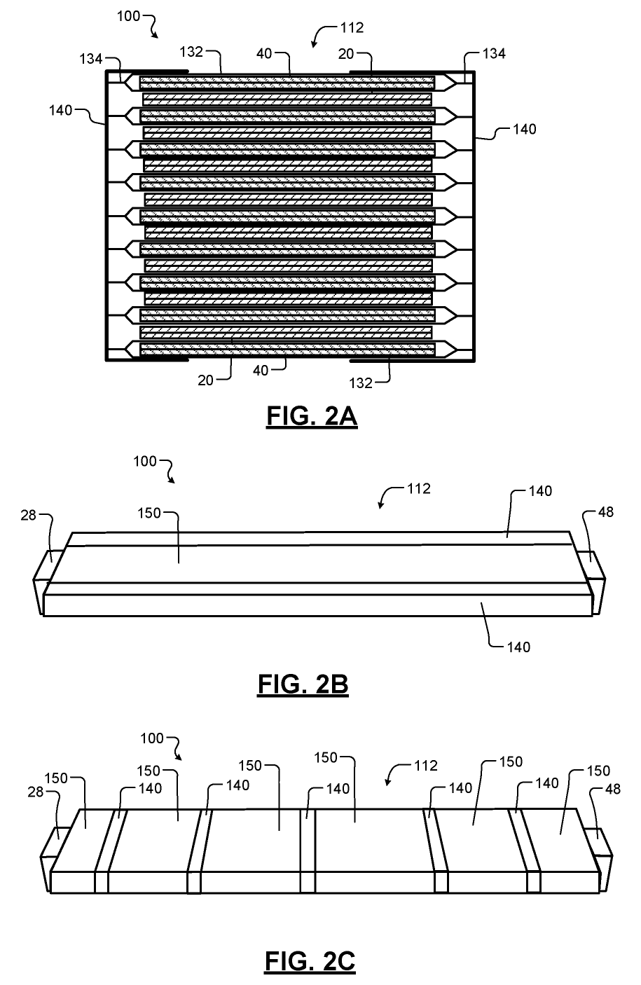

Referring now to FIG. 2A to FIG. 2C, a battery cell 100 comprises a battery cell stack 112 including the C cathode electrodes 20, the A anode electrodes 40, and S separators 132. Ends 134 of the S separators 132 extend from opposite sides of the battery cell 100. After lamination and stacking, tape 140 may be used to provide additional support to hold the battery cell stack 112 together. The tape 140 is wrapped around selected portions of the battery cell stack 112 to provide additional support.

In FIG. 2B, the tape 140 can be applied along longitudinal edges of the battery cell 100. However, this approach requires a lot of tape which is expensive. In FIG. 2C, the tape 140 can be applied at one or more discrete locations in a direction transverse to a longitudinal direction to reduce cost (with untapped regions 150 there between). In some examples, the tape 140 meets and overlaps in the middle of the battery cell 100. In other examples, the tape 140 does not overlap in the middle.

The tape 140 is connected over ends 134 of the S separators 132. While examples of patterns of the tape 140 are shown in FIG. 2B and FIG. 2C, other taping patterns can be used. When the tape 140 covers only part of the C cathode electrodes 20 and the A anode electrodes 40, there is a higher risk of pull back or folding of the S separators 132 in locations 150 where no tape is applied. The soft short circuits typically occur due to the S separators 132 pulling back or folding.

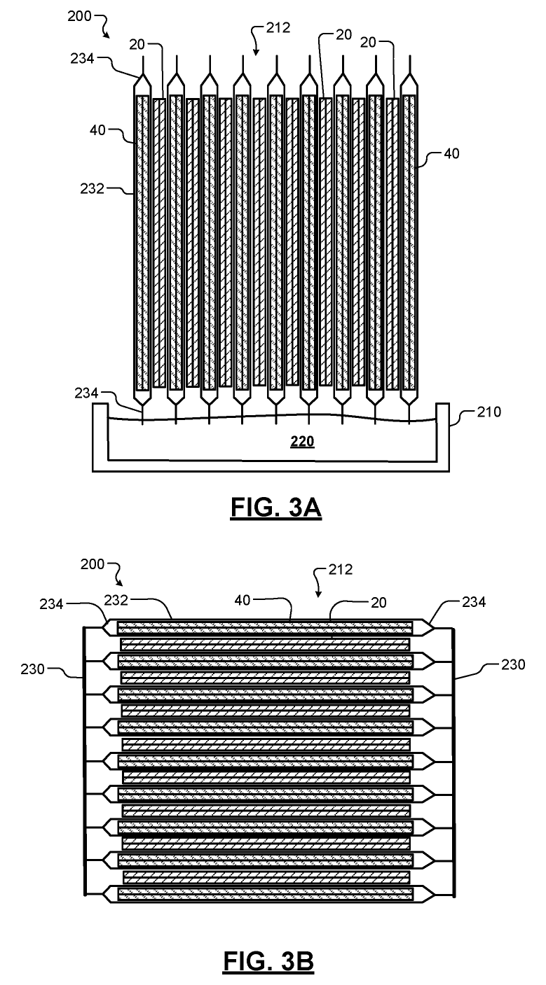

Referring now to FIG. 3A and FIG. 3B, a battery cell 200 comprises a battery cell stack 212 including the C cathode electrodes 20, the A anode electrodes 40, and S separators 232. Ends 234 of the S separators 232 extend from sides of the battery cell stack 212.

The ends 234 of the S separators 232 are dipped into a bath 210 as shown in FIG. 3A. The bath 210 includes an adhesive such as a polymer material 220 in a liquid or molten state. The S separators 232 typically include a polymer component allowing the polymer material 220 to bond the S separators together to form a polymer connector 230 as shown in FIG. 3B.

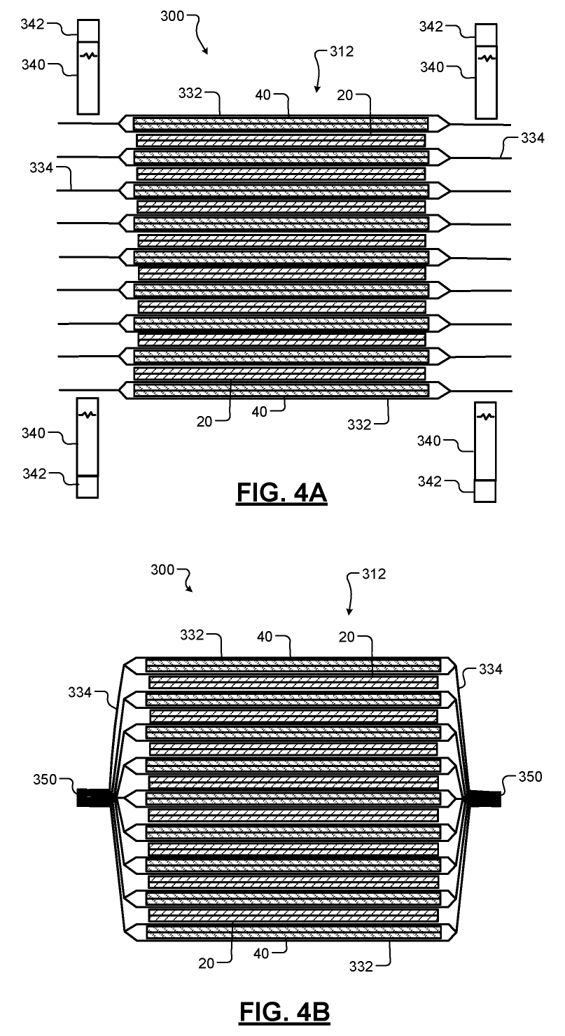

Referring now to FIG. 4A and FIG. 4B, a battery cell 300 comprises a battery cell stack 312 including the C cathode electrodes 20, the A anode electrodes 40, and S separators 332. The S separators 332 include ends 334 extending from sides of the battery stack 312.

In FIG. 4A, the ends 334 are arranged between hot press members 340. Actuators 342 move the hot press members 340 together to contact with the ends 334 of the S separators 332. After pressing and heating the ends 234 of the S separators 332 together using the hot press members 340, the ends 334 of the S separators 332 are bonded together to form a connection 350 as shown in FIG. 4B. After bonding, the ends of the S separators 332 can be trimmed as needed.

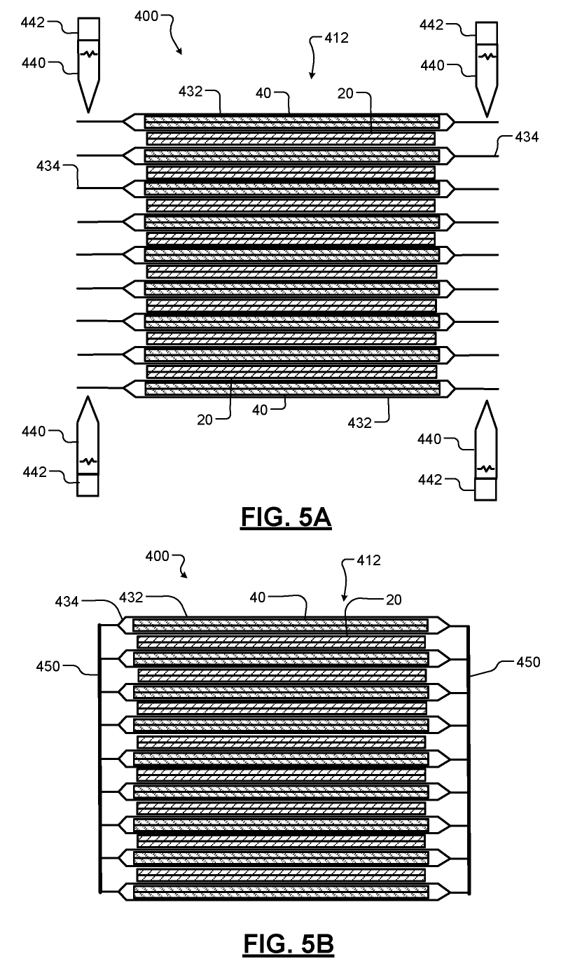

Referring now to FIG. 5A and FIG. 5B, a battery cell 400 comprises a battery cell stack 412 including the C cathode electrodes 20, the A anode electrodes 40, and S separators 432. The S separators 432 include ends 434 extending from sides of the battery stack 412.

In FIG. 5A, the ends 434 of the S separators 432 are heated and cut by one or more hot knife members 440 (e.g., between two hot knife members or between a hot knife member and a planar surface). Actuators 442 move the hot knife members 440 to heat, join, and cut the ends 434 of the S separators 432 to form a connection 450.

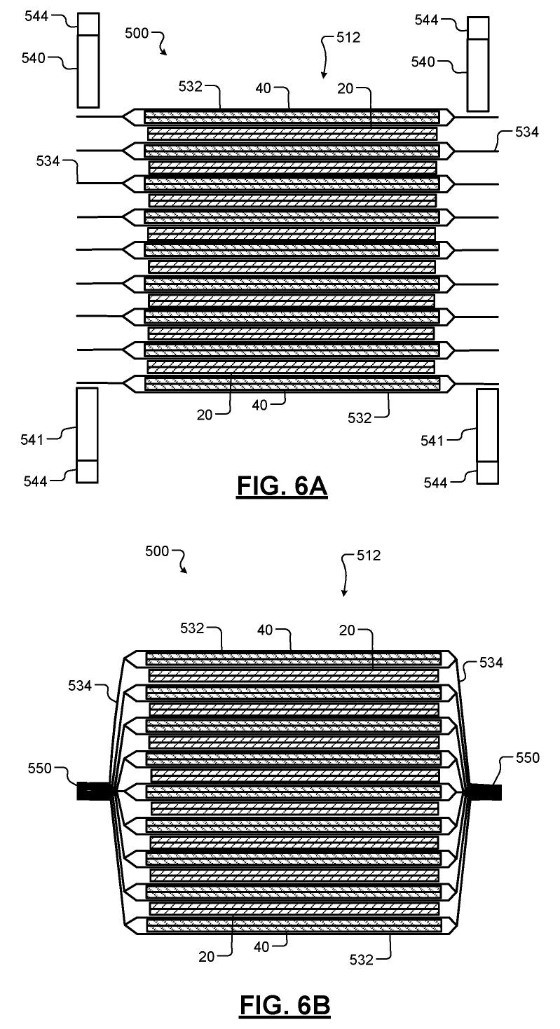

Referring now to FIG. 6A and FIG. 6B, a battery cell 500 comprises a battery cell stack 512 including the C cathode electrodes 20, the A anode electrodes 40, and S separators 532. The S separators 532 include ends 534 extending from sides of the battery stack 512.

In FIG. 6A, ends 534 of the S separators 532 are arranged between a horn 540 and an anvil 541 of an ultrasonic welder 542. Actuators 544 move the horn 540 and the anvil 541 of the ultrasonic welder 542 together around the ends 534 of the S separators 532. Ultrasonic vibration is used to weld the S separators 532 together to form a connection 550.

By joining ends of all of the separators together on each side, there is a lower risk for one or more separators of the battery cell according to the present disclosure to pull back or fold. As a result, the reliability of the battery cell is improved due to the reduced likelihood of soft short circuits. In addition, some examples of the battery cell eliminate the use of tape, which reduces cost.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
C cathode electrodes each including a cathode active material arranged on a cathode current collector;
A anode electrodes each including an anode active material arranged on an anode current collector; and
S separators, wherein C, A, and S are integers greater than one,
wherein the S separators include first ends and second ends,
wherein the first ends and the second ends of the S separators extend from opposite sides of the C cathode electrodes and the A anode electrodes,
wherein the first ends of the S separators are connected together.

2. The battery cell of claim 1, wherein the second ends of the S separators are connected together.

3. The battery cell of claim 2, wherein the first ends and the second ends of the S separators are connected together using a hot press.

4. The battery cell of claim 2, wherein the first ends and the second ends of the S separators are connected together using a hot knife.

5. The battery cell of claim 2, wherein the first ends and the second ends of the S separators are connected together using a polymer connector.

6. The battery cell of claim 5, wherein the polymer connector is formed by dipping the first ends and the second ends of the S separators in a polymer bath.

7. The battery cell of claim 1, wherein the first ends and the second ends of the S separators are connected together using ultrasonic welding.

8. The battery cell of claim 2, further comprising tape extending over at least a portion of the first ends and the second ends of the S separators.

9. The battery cell of claim 8, wherein the tape is located at discrete locations that are spaced in a longitudinal direction.

10. A vehicle comprising a battery module including a plurality of the battery cell of claim 1.

11. A method for manufacturing a battery cell, comprising:
arranging C cathode electrodes each including a cathode active material arranged on a cathode current collector, A anode electrodes each including an anode active material arranged on an anode current collector, and S separators in a battery cell stack, wherein C, A, and S are integers greater than one,
wherein the S separators include first ends and second ends,
wherein the first ends and the second ends of the S separators extend from opposite sides of the C cathode electrodes and the A anode electrodes; and
connecting the first ends of the S separators together.

12. The method of claim 11, further comprising connecting the second ends of the S separators together.

13. The method of claim 12, wherein the first ends and the second ends of the S separators are connected together using a hot press.

14. The method of claim 12, wherein the first ends and the second ends of the S separators are connected together using a hot knife.

15. The method of claim 12, wherein the first ends and the second ends of the S separators are connected together using a polymer connector.

16. The method of claim 12, further comprising dipping the first ends and the second ends of the S separators in a polymer bath to form a first polymer connector connecting the first ends and a second polymer connector connecting the second ends.

17. The method of claim 11, wherein the first ends and the second ends of the S separators are connected together using ultrasonic welding.

18. The method of claim 12, further comprising wrapping at least a portion of the first ends and the second ends of the S separators using tape.

19. The method of claim 18, wherein the tape is located at discrete locations that are spaced along the battery cell in a longitudinal direction.

20. The method of claim 11, further comprising:
arranging a plurality of the battery cell in a battery module; and
arranging the battery module in a vehicle.
